(19) United States
(12) Patent Application Publication
(10) Pub. No.: US 2021/0133795 A1
(43) Pub. Date: May 6, 2021

(54) METHODS AND SYSTEMS FOR ELECTRONICALLY REWARDING TRAVELERS FOR USAGE OF THEIR TRAVEL ITINERARIES BY OTHER TRAVELERS

(71) Applicants: Kunal DESAI, Menlo Park, CA (US); Parag MEHTA, San Jose, CA (US); Amul SHAH, Palatine, IL (US)

(72) Inventors: Kunal DESAI, Menlo Park, CA (US); Parag MEHTA, San Jose, CA (US); Amul SHAH, Palatine, IL (US)

(21) Appl. No.: 17/090,526

(22) Filed: Nov. 5, 2020

Related U.S. Application Data
(60) Provisional application No. 62/930,579, filed on Nov. 5, 2019.

(51) Int. Cl. G06Q 30/02; G06Q 10/02; G06Q 50/00; G06F 16/955

(52) U.S. Cl. CPC G06Q 30/0239; G06F 16/955; G06Q 50/01; G06Q 10/025

(57) ABSTRACT

A computer-implemented method for providing an application to reward travelers for causing bookings with their travel itinerary. The computer-implemented method includes facilitating an application to run on a first user device of a first traveler and a second user device of a second traveler. The computer-implemented method includes receiving a travel itinerary including one or more travel events, uploaded by the first traveler through the application. The computer-implemented method includes generating a plurality of hyperlinks directed to third-party booking sites, based on one or more travel events. The computer-implemented method includes facilitating one or more second travelers to view the travel itinerary and subsequently make bookings through the application. The computer-implemented method includes determining rewards for the first traveler, based on successful bookings made by the one or more second travelers by clicking on at least one of the plurality of hyperlinks on the travel itinerary of the first traveler.

### BACKGROUND

People travel for various reasons. Some travel for work, others for fun, and some for finding mental peace. Though every person may have his/her reason to go on a journey, it is essential to note that traveling is a favorite hobby for thousands of people across the globe. Traveling is fun and also brings many benefits such as enriching awareness, providing perspectives, education, and learning/improving soft skills.

With the advent of technology and social media, a traveler's journey has changed from what it used to be. Travelers no longer rely on guidebooks or paper maps to reach their destination. Instead, travelers have the privilege of spontaneous access to information across the web. Many travelers like to share their travel experiences with members of their social networks. With real-time images shared during travel events, travelers often inspire newcomers. This real-time access to travel information has eventually changed the way travelers' approach towards planning a trip and making bookings for the plan.

There are numerous travel planning systems and computer programs for providing travel information based on information obtained from other travelers. Generally, users are required to manually enter their travel information and perform their travel-related searches. The process of manually entering the travel information can be time-consuming, inefficient, and may also be inaccurate.

Further, there are several web-based travel planning systems that allow individuals to book a travel itinerary that is designed by the system and may also allow small customizations. On the other hand, travelers do not feel motivated to share their travel itineraries with unknown or known people. In light of the above discussion, there exists a need for electronic methods and systems to reward travelers for sharing their traveling experience.

### SUMMARY

Various embodiments of the present disclosure provide methods and systems for rewarding a traveler for causing bookings of various travel events by sharing his/her travel itinerary.

In an embodiment, a computer-implemented method is disclosed. The computer-implemented method includes facilitating, by a server system, an application to run on a first user device and a second user device. The first user device may be associated with a first traveler and the second user device may be associated with a second traveler. The computer-implemented method includes receiving, by the server system, a travel itinerary uploaded by the first traveler through a user interface (UI) of the application running on the first user device. The travel itinerary may include one or more travel events updated by the first traveler. The computer-implemented method includes generating, by the server system, a plurality of hyperlinks, based, at least in part on the one or more travel events. The plurality of hyperlinks may be directed to third-party booking sites. The computer-implemented method includes facilitating, by the server system, one or more second travelers to view the travel itinerary and subsequently make bookings through the UI of the application running on the second user device. The bookings may be made by clicking on at least one of the plurality of hyperlinks directed to third-party booking sites. The computer-implemented method includes determining, by the server system, rewards for the first traveler, based, at least in part on, successful bookings made by the one or more second travelers by clicking on at least one of the plurality of hyperlinks on the travel itinerary uploaded by the first traveler.

In another embodiment, a server system is disclosed. The server system includes a memory configured to store executable instructions and a processor configured to execute the executable instructions stored in the memory and thereby cause the server system to facilitate an application to run on a first user device and a second user device. The first user device may be associated with a first traveler and the second user device may be associated with a second traveler. The server system is caused to receive a travel itinerary uploaded by the first traveler through a user interface (UI) of the application running on the first user device. The travel itinerary may include one or more travel events updated by the first traveler. The server system is further caused to generate a plurality of hyperlinks, based, at least in part on one or more travel events. The plurality of hyperlinks may be directed to third-party booking sites. The server system is caused to facilitate one or more second travelers to view the travel itinerary and subsequently make bookings through the UI of the application running on the second user device. The bookings may be made by clicking on at least one of the plurality of hyperlinks directed to third-party booking sites. The server system is further caused to determine rewards for the first traveler, based, at least in part on, successful bookings made by the one or more second travelers by clicking on at least one of the plurality of hyperlinks on the travel itinerary uploaded by the first traveler.

In yet another embodiment, a system is disclosed. The system includes a database, a user interface (UI) module, an application management module, an itinerary creation module, an itinerary sharing module, and a traveler reward module. The UI module is in communication with the database. The UI module is configured to present one or more user interfaces (UI's) for facilitating the plurality of travelers to create, upload, and view, one or more travel itineraries. The application management module is configured to manage downloads and usage of an application on a plurality of user devices. The itinerary creation module is in communication with the UI module and the database. The itinerary creation module is configured to generate travel itineraries, based on, at least one of a travel event updated by a traveler through the application on a user device. The itinerary sharing module is in communication with the UI module and the database. The itinerary sharing module is configured to facilitate one or more travelers to click on at least one hyperlink embedded in a travel itinerary. The traveler reward module is in communication with the UI module and the database. The traveler reward module is configured to determine rewards for the plurality of travelers.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

For a more complete understanding of example embodiments of the present technology, reference is now made to the following descriptions taken in connection with the accompanying drawings in which:

FIG. 1A is an illustration of an environment, where at least some example embodiments can be practiced;

FIG. 1B is a block diagram of one preferred system architecture, in accordance with an example embodiment;

FIG. 2 is a simplified block diagram of a server system, in accordance with an example embodiment;

FIG. 3 is a sequence flow diagram for determining and sending rewards to a first traveler, in accordance with an example embodiment;

FIG. 4A is a block diagram illustrating the creation of a travel itinerary by a first traveler, in accordance with an example embodiment;

FIG. 4B is a block diagram illustrating the process of rewarding a first traveler based on a successful booking made by a second traveler, in accordance with an example embodiment;

FIG. 5A is an example representation of a user interface (UI) displayed on the first user device by the travel application, in accordance with an example embodiment;

FIG. 5B is an example representation of the UI displayed on the first user device by the travel application, in accordance with an example embodiment;

FIG. 5C is an example representation of the UI displayed on first the user device by the travel application, in accordance with an example embodiment;

FIG. 5D is an example representation of a UI displayed on the second user device by the travel application, in accordance with an example embodiment;

FIG. 6 is a flow diagram illustrating a computer-implemented method for determining rewards for a first traveler, via an application, in accordance with an example embodiment;

FIG. 7 is a flow diagram illustrating a method to reward travelers for causing bookings with their travel itinerary, in accordance with an example embodiment; and

FIG. 8 is a simplified block diagram of an electronic device, in accordance with an example embodiment.

The drawings referred to in this description are not to be understood as being drawn to scale except if specifically noted, and such drawings are only exemplary in nature.

### DETAILED DESCRIPTION OF THE EMBODIMENTS

The above-mentioned needs are met by providing a computer-implemented method and system to reward travelers for causing bookings by sharing their travel itinerary. Before describing in detail, the particular computer-implemented method and system, in accordance with various embodiments of the present invention, it should be observed that the present invention resides primarily in a trusted platform for rewarding travelers who cause bookings by sharing their travel itinerary. The following detailed description is intended to provide example implementations to one of ordinary skill in the art and is not intended to limit the invention to the explicit disclosure, as one of ordinary skill in the art will understand that variations can be substituted that are within the scope of the invention as described.

Reference in the specification to “one embodiment”, “an embodiment”, “some embodiments”, or “other embodiments” means that a particular feature, structure, or characteristic described in connection with the embodiments is included in at least one embodiment, but not necessarily in all embodiments of the invention. It is understood that the phraseology and terminology employed herein is not to be construed as limiting and are for a descriptive purpose only.

In the description that follows, references will be made to “first traveler” with reference to an individual who creates his/her travel itinerary and “second traveler” with reference to an individual who views the travel itinerary.

In the description that follows, references will be made to “third-party booking sites” with reference to websites related to parties outside the server system.

### OVERVIEW

Various example embodiments of the present disclosure provide methods and systems for rewarding travelers for causing bookings via travel itineraries posted by him/her.

An application is provided for facilitating travelers to create and post travel itineraries publicly or privately. Further, the application may also facilitate the viewing of a travel itinerary posted by a traveler and make a booking corresponding to one or more travel events in the travel itinerary. The application provides User interfaces (UI's) that enable travelers to upload, view travel itineraries, and also click on travel events to make bookings.

In an embodiment, a server system is configured to facilitate the application to run on a user device. The application may be referred to as a “travel application” configured to perform the operations described herein. The travel application may be downloaded onto the user device via the server system. The travel application may be a mobile application, a computer application, a web application, or the like. In some embodiments, the travel application may also be accessed as a webpage over the internet.

In an embodiment, a traveler may download the travel application on his/her user device, such as a mobile phone. The traveler may take trips often and is willing to share the travel itineraries with other travelers who are interested. The traveler who wishes to create and share a travel itinerary is referred to as a ‘first traveler’ hereinafter. Another traveler who is interested in viewing and using the travel itineraries posted by the first traveler and make bookings using the travel itinerary is referred to as ‘second traveler’ hereinafter.

The first traveler may create and upload a travel itinerary during or after a trip to a particular place. The travel itinerary may include a plurality of travel vents such as stay, food, transportation, local attractions, adventures, activities, etc. The first traveler may update the information regarding each of the one or more travel events. The travel application may provide UIs to the first traveler to update the information associated with a travel event such as the place, time, review, comments, etc. The information updated by the first traveler regarding a travel itinerary including a plurality of travel events may be received by the server system.

In one embodiment, the server system is configured to generate a plurality of hyperlinks associated with one or more travel events in a travel itinerary. The server system may access third-party booking sites to generate the hyperlinks associated with the travel events. The third-party booking sites may be links directed to the websites of travel events such as hotels, places, activities, food joints, etc. The server system may generate the hyperlinks and embed the hyperlinks to the travel itineraries of the first traveler.

In one embodiment, the travel itineraries uploaded by the first travelers may be stored in an itinerary database. The itinerary database may also include user profiles associated with all traveler details of the travelers who have registered to the travel application. In one embodiment, the first traveler may choose to share the travel itinerary publicly. The travel itinerary may be visible to all the travelers on the travel application when it is shared publicly. In another embodiment, the first traveler may save the travel itinerary privately and can share the travel itinerary to desired candidates later as a personal or broadcast message on the travel application.

In one embodiment, the server system facilitates one or more second travelers to view the travel itinerary and subsequently make bookings for the travel events included in the travel itinerary. The travel application may provide a UI to the one or more second travelers to click on a travel event of the travel events included in the travel itinerary and to make bookings on the third-party booking sites associated with the hyperlinks embedded to the travel events in the travel itinerary. When a second traveler clicks on the travel event, the server system may cause the travel application on the user device to redirect the second traveler to the booking site associated with the travel event. The second traveler may view the various booking options available on the booking site and may make a successful booking.

In one embodiment, the third-party booking sites may notify the server system regarding a successful booking caused by the travel application. The notification may include an identifier that facilitates the server system to determine the first traveler whose travel itinerary was utilized to make the subsequent booking. Further, the server system may also receive rewards from the third-party booking sites for causing bookings.

In one embodiment, the server system is configured to determine rewards to be provided to the first traveler based on the number of bookings caused by the travel itinerary that he/she shared. The third-party booking sites may provide a commission to the server system for causing successful bookings. Based on the commission received by the server system, rewards to be provided to the first traveler may be determined. The rewards may be provided periodically to the first traveler based on the successful bookings. For example, the rewards may be provided to the first travelers on a weekly, monthly, quarterly, or yearly basis. The rewards may be provided to the first traveler in the form of commissions, bonuses, gifts, and promotions. Further, the server system is configured to send the rewards to the first traveler over their user device via the travel application.

In one embodiment, the rewards amount may be calculated using a tiered approach. For e.g., tier 1 may include 0-50 successful bookings per month, tier 2 may include 51-150 successful bookings per month, tier 3 may include 150-500 successful bookings per month, and tier 4 may include 500+ successful bookings per month. In one example, travelers belonging to tier 1 may receive 10% of the commission received by the server system, tier 2 may receive 15% of the commission, and so on.

In additional embodiments, the rewards may be determined based on a type of the travel event that is successfully booked by one or more second travelers. For e.g., the first traveler may have included a lunch event, a museum visit, and a hotel stay in a travel itinerary and the museum visit may be booked via the first traveler's travel itinerary for 100 times, whereas the lunch event may be booked for 50 times. Even though the museum visit has been booked more, the first traveler may be rewarded more for the lunch bookings caused by his/her travel itinerary, based on the commission received from the lunch booking site. In another embodiment, the server system may allocate weight values to different travel events such that the travel events with higher weight values may gain higher rewards for the first traveler. In another embodiment, the server system may be configured to record the number of views on the plurality of travel itineraries and may calculate and provide rewards to the travelers whose travel itineraries have crossed a threshold number of views.

Various embodiments of the present disclosure offer multiple advantages and technical effects. For instance, the present disclosure enables travelers to share their travel itineraries using voice or text commands, with other travelers who may be interested in traveling to the same place. In some embodiments, the present disclosure facilitates the automatic updating of travel events based on the location of the user device associated with a traveler. The rewards provided by the travel applications motivate travelers to share their travel itineraries which may be a great help to other travelers. Further, the embedding of the hyperlinks associated with the travel events in a travel itinerary serves as user-friendly to the travelers as it reduces the work of the travelers who may have to check the travel itinerary and then manually type the website. Further, embedding the hyperlinks to the travel itinerary also increases the bookings of travel events. The present disclosure utilizes a tier-based approach to determine rewards to be given to travelers. The tier-based approach facilitates higher rewards for the travelers who caused higher bookings via the travel itineraries that they posted. This approach may motivate the travelers to travel and post more travel itineraries on the travel application and increase their reach and rewards.

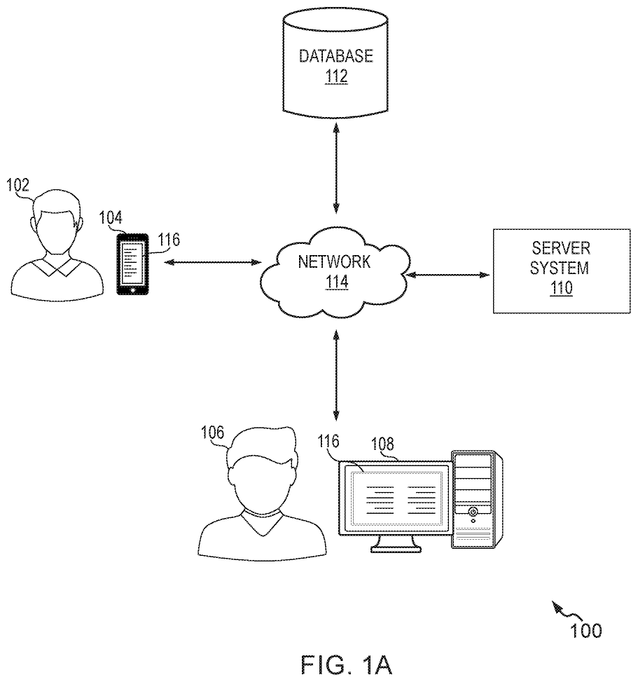

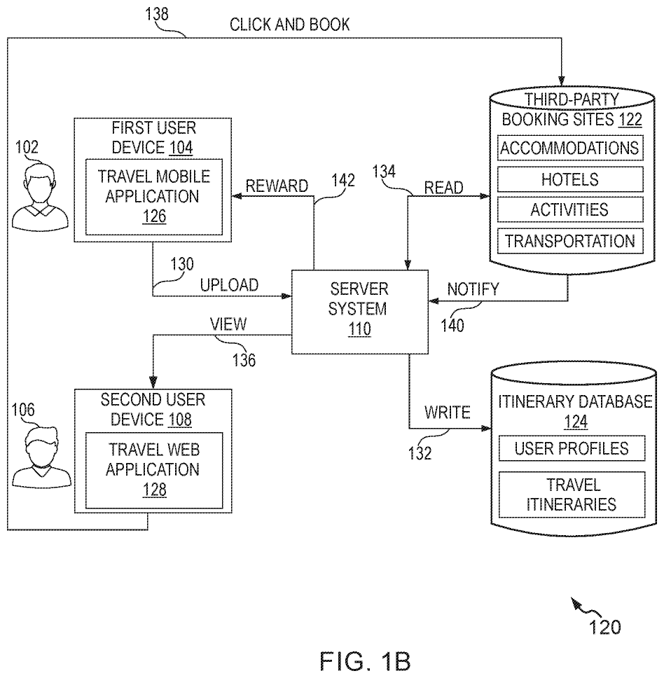

FIG. 1A is an illustration of an environment 100 related to at least some example embodiments of present disclosure. A first traveler 102 associated with a first user device 104 and a second traveler 106 associated with a second user device 108 are shown. It should be noted that the first traveler 102 and the second traveler 106 are shown for the sake of simplicity, there can be more number of travelers. The environment 100 generally includes first user device 104, second user device 108, server system 110, and the database 112 each coupled to, and in communication with (and/or with access to) a communication network (e.g., a network 114). The network 114 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among two or more of the parts or travelers illustrated in FIG. 1, or any combination thereof.

Various entities in the environment 100 may connect to the network 114 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. The network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 114 may include multiple different networks, such as a private network made accessible by the server system 110 to the first user device 104 and the second user device 108, and the database 112 and separately, a public network (e.g., the Internet) through which the server system 110, the first and second user devices 104 and 108, and the database 112 may communicate.

In at least one example embodiment, the first and second user devices 104 and 108 are equipped with a travel application 116 that facilitates a plurality of options included in the application, to first and second travelers 102 and 106. The user devices 104 and 108 may be any communication device having hardware components for enabling User Interfaces (UIs) of the travel application 116 to be presented on the user devices 104 and 108. The user devices 104 and 108 may be capable of being connected to a wireless communication network (such as the network 114). Examples of the user devices 104 and 108 may include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

The first traveler 102 may be an individual who has made a journey from one place to another place through the land, air, and/or water. In some embodiments, the first traveler 102 is a person who is traveling or who often travels to distant places. In some embodiments, the journey may include a plurality of places/locations. The first traveler 102 may create a travel itinerary using the travel application 116. The travel itinerary may include details about his/her journey with important information associated with means of transportation, hotels, day trip information, food, and other activities. In some embodiments, the first traveler 102 may include pictures and/or video snippets associated with the one or more travel events in the travel itinerary. Typically, the travel itinerary is a schedule of travel events (a detailed plan for a journey) and depicts the one or more destinations that are visited at specific times and means of transportation to reach those destinations. It also represents information such as hotels, day trip information, food, and other activities. The travel itinerary ensures time management and helps to organize the journey. It can also help a traveler to anticipate the challenges that may come up during the journey. With that, the traveler can make the necessary preparations and adjustments. The first traveler 102 may post or share the travel itinerary on the travel application 116 or any other social networking sites.

The second traveler 106 may be an individual who wishes to plan his/her journey ahead of time. Specifically, the second traveler 106 views the travel itinerary created by the first traveler 102 to make bookings and plan accordingly based on the experiences posted by the first traveler 102. The travel application 116 facilitates the second traveler 106 to make bookings by clicking on at least one of the travel events embedded with hyperlinks in the travel itinerary posted by the first traveler 102.

In an embodiment, the first traveler 102 creates the travel itinerary for his/her travel plans using the first user device 104. The server system described herein is configured to generate hyperlinks for the travel events posted by the first traveler 102. The hyperlinks may be directed to third-party booking sites. The travel itinerary created by the first traveler 102 may be stored in the database 112. The first traveler 102 may then post the travel itinerary through the network 114 to other travelers or users via the travel application 116 or other social networking sites. It should be noted that the first traveler 102 is allowed to post the travel itinerary before he/she completes the entire journey/trip. In some embodiments, the first traveler 102 may post the travel itinerary consequent to the end of the journey/trip.

In one embodiment, the other travelers, in this case, the second traveler 106 views the travel itinerary created by the first traveler 102 using the travel application 116 on the second user device 108. The second traveler 106 may find a travel event appealing and may want to check out the booking options for the same. The second traveler 106 may then click on the travel event embedded with the hyperlink of that particular travel event and subsequently navigate to the related third-party site. Further, the second traveler 106 may view various booking options provided on the third-party site and make a subsequent booking for his/her future travel plan. Based on a successful booking made by the second traveler 106, rewards may be determined for the first traveler 102 by the server system 110 for causing booking by sharing his/her travel itinerary.

The database 112 stores destinations, attractions, accommodations, restaurants, events. Typically, the database 112 may store all the travel itineraries created by a plurality of travelers using the travel application 116 described herein. The database 112 may also add activities, images, and other information automatically to the travel itineraries created by travelers. Further, the database 112 is adapted to store user profile data, for instance, the traveler's names, rewards account number, credit card account numbers, age, address(es), contact information, and so on.

FIG. 1B is a block diagram 120 of one preferred system architecture related to at least some example embodiments of the present disclosure. The block diagram 120 shows the first traveler 102 associated with the first user device 104, the second traveler 106 associated with the second user device 108, a server system 110, third-party booking sites 122, and itinerary database 124. The first traveler 102 is shown to be using a travel mobile application 126 on the first user device 104 and the second traveler 106 is shown to be using a travel web application 128 on the second user device 108. It is exemplarily shown that the third-party booking sites 122 may include the sites of a hotel, accommodations, activities, and transportation. It should be noted that third-party booking sites are only shown for exemplary purposes and do not limit the scope of the invention. Further, the itinerary database 124 may store user profiles and travel itineraries uploaded by various travelers via the travel web application and/or travel mobile applications.

The first traveler 102 and the second traveler 106 may download the travel application 116 on their respective devices via the server system 110. The server system 110 is configured to facilitate the travel application 116 in various forms onto the first and second user devices 104 and 108. In one example, the first traveler 102 may be using a mobile phone and will be facilitated to download the travel mobile application 126 on the first user device 104. The second traveler 106 may be using a desktop and may be facilitated by the server system 110 to access the travel web application 128 on a desktop of the second user device 108. The first and the second travelers 102 and 106 may utilize the travel application 116 in any form and may be capable of performing various operations provided by the travel application 116 via the server system 110.

In an example embodiment, the first traveler 102 may utilize the travel mobile application 126 on the first user device 104 and upload a travel itinerary (see, 130). The travel mobile application 126 may provide UIs to the first traveler 102 that facilitates the first traveler 102 to update a plurality of information regarding a trip that he/she is just finished or is currently on. The information may include travel events such as accommodation, transportation, activities, adventures, food, etc. The first traveler 102 may create a day-wise travel itinerary including a number of travel events and upload it on the travel mobile application 126. The first traveler 102 may also share the travel itineraries on various social media sites. In one embodiment, the first traveler 102 may choose to share the travel itinerary publicly, or alternatively, the first traveler 102 may save the travel itinerary privately and share it with the desired candidates personally.

In one embodiment, the server system 110 is configured to store (see, 132) the travel itinerary uploaded by the first traveler 102 in the itinerary database 124. The itinerary database 124 includes user profiles of the travelers and travel itineraries stored by the corresponding travelers. The itinerary database 124 stores destinations, attractions, accommodations, restaurants, events, and tours. Typically, it stores all the travel itineraries created by the travelers using the travel application described herein. The itinerary database 124 also adds activities, images, and other information automatically to the travel itineraries recommended by the travelers. Further, the itinerary database 124 is adapted to store user profile including traveler details associated with the plurality of travelers, for instance, the traveler's names, rewards account number, credit card account numbers, age, address(es), contact information, and so on.

In one embodiment, the server system 110 is configured to generate hyperlinks associated with the travel events in the travel itinerary uploaded by the first traveler 102 and embed the hyperlinks to the travel itinerary. The server system may access the third-party booking sites 122 to generate hyperlinks of the travel events (see, 134). The third-party booking sites 122 may be a database that stores all the basic travel components that are developed during a journey. Examples of these travel components include, but are not limited to, travel accommodation, tours, local cruises, entry tickets to local attractions (theme parks, cinemas, zoos, museums, galleries, and so on) and meals (for instance, local restaurant bookings/reservations). The hyperlinks when accessed by any of the travelers may lead the traveler's user device to access the websites of the corresponding travel event such as activities, food, or local attractions.

Further, the server system 110 may facilitate sharing of the travel itinerary to one or more second travelers (e.g., the second traveler 106). The travel itineraries may be shared on the travel mobile application 126 itself or on social networking sites. In one example embodiment, the second traveler 106 may view (see, 136) the travel itinerary posted by the first traveler 102. The second traveler 106 will be facilitated to view the travel itineraries posted by the travelers on the travel web application 128. The travel itineraries may be searched by the second traveler 106 based on the place that they want to travel or the server system 110 may randomly show the travel itinerary in a news feed format on the second traveler's travel web application 128. In some embodiments, the server system 110 may use simple data analysis based on the second traveler's previous search and application data collected upon travelers' consent.

Further in an embodiment, the second traveler 106 may click on one hyperlink embedded in the travel itinerary and make a subsequent booking on the booking site associated with the hyperlink (see, 138). The second traveler 106 may just click on a travel event that he/she is interested in and the server system 110 is configured to redirect the travel web application 128 to the booking site of the travel event. The booking site may display a plurality of booking options available for the second traveler 106 and the second traveler 106 may make a successful booking on the booking site. For example, the second traveler 106 may click on the lunch event included in the travel itinerary and may book a table for lunch for a particular date and time.

The server system 110 is configured to receive an identifier based on the successful booking made by the second traveler 106. The third-party site may notify (see, 140) the server system 110 regarding a successful booking caused by a first traveler's itinerary. The notification may include an identifier of the first traveler 102 whose itinerary was utilized. In some embodiments, the second traveler 106 may open the booking site for a particular entity such as lunch but may book a room to stay in the same hotel. In such scenarios also, the booking site may notify the server system 110 regarding a successful booking caused by the travel itinerary of the first traveler 102.

Further, the server system 110 is configured to determine rewards to be given to the first traveler 102 for causing a booking via their travel itinerary. The rewards may be sent to the first traveler 102 via the travel mobile application 126 (see, 142). At first, the server system 110 may receive rewards or commission from the third-party booking sites for causing their users to make successful bookings from their sites. Further the server system 110 may determine the rewards to be periodically provided to the first traveler 102 based on the rewards received by the third-party booking sites. In one embodiment, the rewards may be periodic and provided for each of the bookings caused. Alternatively, the rewards provided to the first travelers may be weekly, quarterly, or yearly. In additional embodiments, the rewards may be determined based on a tiered approach. For e.g., tier 1 may include 0-50 successful bookings per month, tier 2 may include 51-150 successful bookings per month, tier 3 may include 150-500 successful bookings per month, and tier 4 may include 500+ successful bookings per month. Each tier may get a different percentage of the rewards received by the server system 110 from the third-party booking sites.

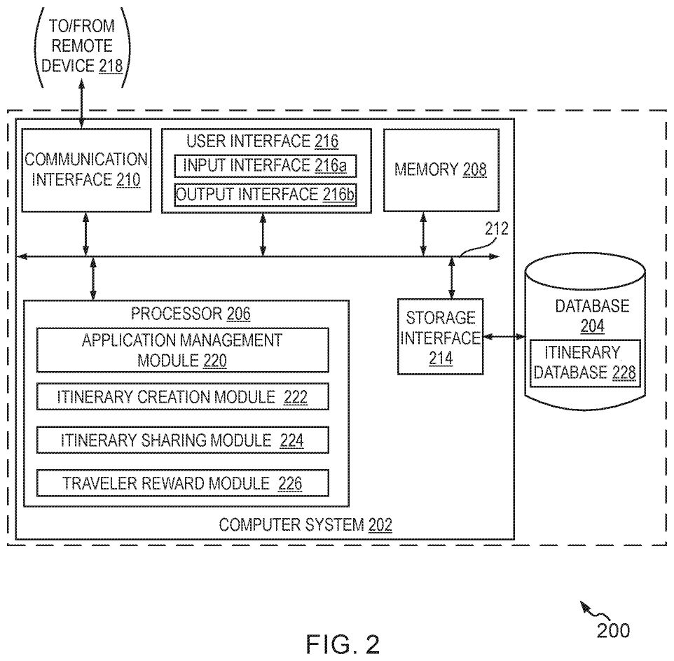

Referring now to FIG. 2, a simplified block diagram of a server system 200, is shown, in accordance with an embodiment of the present disclosure. For example, the server system 200 is similar to the server system 110 as described in FIGS. 1A and 1B. In some embodiments, the server system 200 is embodied as a cloud-based and/or SaaS-based (software as a service) architecture. In one embodiment, the server system 200 includes a computer system 202 and a database 204. The computer system 202 includes at least one processor 206 for executing instructions, a memory 208, and a communication interface 210. The one or more components of the computer system 202 communicate with each other via a bus 212.

In one embodiment, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 may include an itinerary database 228 similar to the itinerary database 124 as described in FIG. 1B. The itinerary database 228 is configured to store at least the traveler details associated with the plurality of travelers and travel itineraries uploaded by the plurality of travelers.

The processor 206 includes suitable logic, circuitry, and/or interfaces to execute computer-readable instructions for determining rewards for a first traveler (e.g., the first traveler 102) for causing a successful booking via a travel itinerary posted by the first traveler 102.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In some embodiments, the memory 208 may be realized in the form of a database server or a cloud storage working in conjunction with the server system 200, without deviating from the scope of the present disclosure.

A user interface module 216 is in communication with the database 204. The user interface module 216 is configured to present one or more UIs for facilitating various operations such as uploading a travel itinerary, viewing and accessing a booking site associated with a travel event, etc. The UI module 216 includes an input interface 216a and an output interface 216b. The input interface 216a is configured to receive inputs from the travelers such as places, images, videos, dates and times regarding a travel itinerary. Further, the input interface is configured to receive user details associated with all the travelers logging in to the travel application 116. Examples of the input interface 216a may include but are not limited to, a keyboard, a mouse, a joystick, a keypad, a touch screen, soft keys, a floppy disk, a pen drive, a hard drive, and the like. The output interface 216b is configured to display the UIs for facilitating viewing of the travel itineraries and periodically providing rewards to the travelers. Examples of the output interface 216b may include, but are not limited to, a display such as a light emitting diode (LED) display, a thin-film transistor (TFT) display, a liquid crystal display, an active-matrix organic light-emitting diode (AMOLED) display, and the like.

The processor 206 is operatively coupled to the communication interface 210 such that the processor 206 is capable of communicating with a remote device 218 such as first and second user devices 104 and 108, or with any entity connected to the network 114 (e.g., as shown in FIG. 1A).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes an application management module 220, an itinerary creation module 222, an itinerary sharing module 224, and a traveler reward module 226. It should be noted that the components, described herein, can be configured in a variety of ways, including electronic circuitries, digital arithmetic and logic blocks, and memory systems in combination with software, firmware, and embedded technologies.

In one embodiment, the application management module 220 is configured to facilitate the downloading and usage of the travel application such as the travel application 116 described in FIG. 1A, on the user devices such as the first and second user devices 104 and 108. The application management module 220 may allow the first and second travelers 102 and 106 to download a suitable format of the travel application 116 onto their user devices, such as the first and second user devices 104 and 108. The travel application 116 may be downloaded as a mobile application, a web application, or maybe accessed via a website. Further, the updates of the travel application 116 and other software functionalities of the travel application 116 may be remotely carried out via the first and second user devices 104 and 108 through the application management module 220. The application management module 220 may also be configured to allow the new users to register for the travel application 116. The details of the new travelers registering to the travel application 116 may be stored in the itinerary database 228 included in the database 204. The application management module 220 may also include a plurality of application program interfaces (APIs) configured to facilitate the usage of the travel application 116 on various user devices.

The itinerary creation module 222 is configured to facilitate a first traveler such as the first traveler 102 to create and upload a travel itinerary on the travel application 116. The itinerary creation module 222 may be in communication with the database 204 and the UI module 216. In an example embodiment, the first traveler 102 may wish to upload a travel itinerary associated with a trip that he/she just finished. The travel itineraries may also be uploaded during the trip is still in progress or once the trip is over. The first traveler 102 may update various travel events such as breakfast, transportation, stay, activates, lunch, local attractions, dinner, coffee, etc. The UI module 216 may facilitate the first traveler 102 to update various information regarding travel events such as the date and time, the name of the facility (for e.g., Hotel name, destination name, etc.). The first traveler 102 is also allowed to update pictures and videos associated with the travel event if he/she desires. In some embodiments, the processor 206 is configured to automatically fill in the information such as date-time and add sample pictures of the places by accessing them from the database 204.

In an additional embodiment, the processor 206 is configured to fully automatically upload a travel event based on the location of the first user device 104 associated with the first traveler 102 using the Global positioning system (GPS) sensors of the first user device 104. The automatic updating of the travel events may be performed only upon the first travelers' consent.

The itinerary creation module 222 is configured to generate hyperlinks associated with the travel events and embed them into the travel itinerary of the first traveler 102. The itinerary creation module 222 may access third-party booking sites 122 to generate hyperlinks and embed them to the corresponding travel event in the travel itinerary. For example, the first traveler 102 may wish to update a travel event of lunch at ABC restaurant on Oct. 10, 2020 at 2:00 PM in New York City. The first traveler 102 may input all the details on the travel application 116 and the itinerary creation module 222 is configured to access the site of the ABC restaurant and embed a hyperlink associated with the website of the ABC restaurant in the travel itinerary. Similarly, the itinerary creation module 222 may generate and embed hyperlinks associated with all the travel events in a travel itinerary updated by the first traveler 102.

In one embodiment, the processor 206 is configured to store the travel itinerary uploaded by a plurality of travelers in the itinerary database 228. The travel itineraries may be stored against the travelers' profiles stored in the itinerary database 228.

Further, in an embodiment, the first traveler 102, after the creation of a travel itinerary, may choose to share the travel itinerary publicly or may save the travel itinerary privately. The first traveler 102 may also choose to share the travel itinerary with only selected travelers personally through messages shared on the travel application 116.

The itinerary sharing module 224 is configured to facilitate the travelers on the travel application 116 to share the travel itineraries publicly or privately. In an embodiment, if a traveler wishes to send a travel itinerary to only selected travelers, the itinerary sharing module 224 is configured to allow the first traveler 102 to save the travel itinerary privately and then send the travel itinerary to the desired candidates via a text message on the travel application 116 itself. In some embodiments, the travel itineraries may also be shared via external apps such as social networking sites, etc.

In another embodiment, when the first traveler 102 wants to share the travel itinerary publicly, the itinerary sharing module 224 is configured to facilitate the sharing of the travel itinerary on the travel application 116 and on other social networking sites in a non-restrictive manner. Anyone who desires to view the itinerary is free to view the travel itinerary.

In an embodiment, the itinerary sharing module 224 is configured to display the travel itinerary to the second traveler 106 based on a search operation performed by the second traveler 106 on the travel application 116. The travel itineraries may be searched by the second traveler 106 based on the place that they want to travel or the itinerary sharing module 224 may randomly show the travel itinerary on the second travelers' feed on the second traveler's travel application. In some embodiments, the itinerary sharing module 224 may perform data analysis on the second traveler's previous search and application data collected upon travelers' consent. The data analysis may be used to display more related travel itineraries to the second traveler 106 that the second traveler 106 is interested in.

The UI module 216 is configured to allow the second traveler 106 to view and click on a travel event present in the travel itinerary. In an embodiment, when the second traveler 106 is searching for the desired place to visit, the second traveler 106 may search for the same on the travel application 116. The itinerary sharing module 224 may display a number of results based on the search. The second traveler 106 may then choose the desired travel itinerary that he/she is interested in and check the travel events on the travel itinerary. The second traveler 106 may then desire to book a travel event that the second traveler 106 is interested in. Since the travel events are embedded with the hyperlinks associated with the third-party booking sites, the second traveler 106 may be directed to the third-party site of the travel event selected by the second traveler. The second traveler 106 may then make a successful booking on the third-party site. The third-party site is configured to notify the server system 200 including an identifier associated with the first traveler 102 that caused the successful booking via their travel itinerary. The third-party site may provide rewards to the server system 200 for causing a booking via the travel application 116.

In one embodiment, the traveler reward module 226 is configured to determine rewards to be provided to the first traveler 102 based on the reward received by the server system 200 from third-party booking sites and the number of successful bookings caused by the traveler itinerary posted by the first traveler 102. In an embodiment, the traveler reward module 226 may use a tier-based approach to determine the reward to be provided to the first traveler 102. For e.g., tier 1 may include 0-50 successful bookings per month, tier 2 may include 51-150 successful bookings per month, tier 3 may include 150-500 successful bookings per month, and tier 4 may include 500+ successful bookings per month. Each tier may get a certain percentage of the rewards received by the server system 200 from the third-party booking sites. For example, tier 1 may receive 5% of the rewards, tier 2 may receive 10% of the rewards, and so on. The rewards provided to the first traveler 102 are directly proportional to the number of successful bookings caused by the travel itinerary posted by the first traveler 102. The rewards may be provided to the first traveler 102 in the form of commissions, bonuses, gifts, and promotions. Further, the processor 206 is configured to send the rewards to the first traveler 102 over their user device via the travel application 116.

In additional embodiments, the traveler reward module 226 may determine rewards based on a type of the travel event that is successfully booked by one or more second travelers such as the second traveler 106. For e.g., the first traveler 102 may have included dinner, an art gallery visit, and a hotel stay in a travel itinerary and the art gallery visit may be successfully booked via the first traveler's travel itinerary for 125 times, whereas the hotel stay may be successfully booked for 220 times. Even though the hotel stay has been booked more, the first traveler 102 may be rewarded more for the bookings for an art gallery visit, based on the commission received from the art gallery site.

In another embodiment, the traveler reward module 226 is configured to allocate weight values to different travel events such that the travel events with higher weight values would give higher rewards for the first traveler 102. For e.g., the traveler reward module 226 may provide a higher weight value to a rare travel event such as scuba diving or sky diving event than that of a hotel booking. Therefore, if such events are successfully booked by one or more second travelers, the rewards may be higher than that of a successful hotel booking.

In another embodiment, the traveler reward module 226 may be configured to record the number of views on a plurality of travel itineraries uploaded by the first traveler 102 and may provide rewards to the travel itineraries that have crossed a threshold number of views.

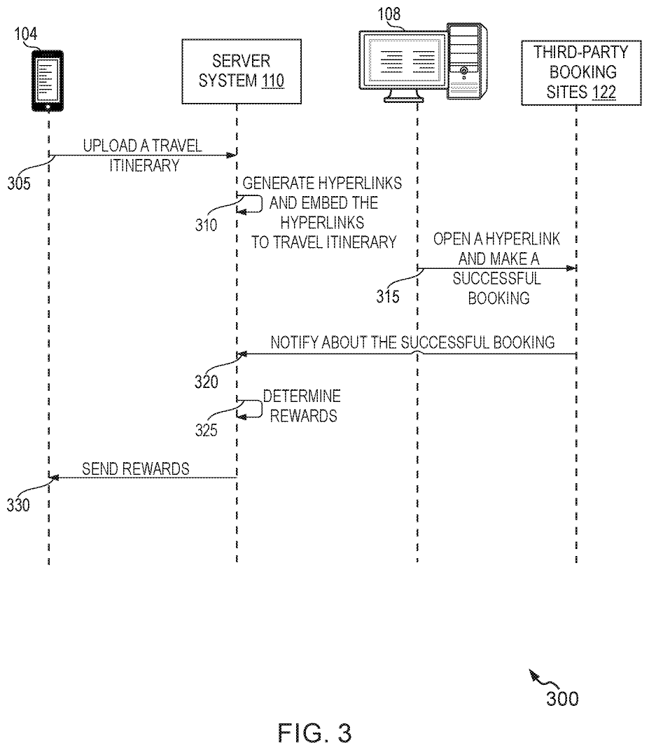

FIG. 3 is a sequence flow diagram 300 for determining and sending rewards to a first traveler (e.g., the first traveler 102), in accordance with an example embodiment. The sequence of operations of the sequence flow diagram 300 may not be necessarily executed in the same order as they are presented. Further, one or more operations may be grouped together and performed in form of a single step, or one operation may have several sub-steps that may be performed in parallel or in a sequential manner.

At 305, the first traveler 102 may upload a traveler itinerary using the travel application 116 downloaded on the first user device 104 via the server system 200. The first traveler 102 may upload various travel events such as stay at XYZ hotel, scuba diving at blue beach, lunch at AXZ delicacy, and the like. The first traveler 102 may be provided with suitable UI to easily upload the details, pictures, small video snippets, etc., via the travel application 116. The first traveler 102 may then choose to privately or publicly share the travel itinerary created by him/her.

At 310, the server system 110 is configured to generate hyperlinks associated with one or more travel events in the travel itinerary uploaded by the first traveler 102. The hyperlinks may be directed to third-party booking sites of hotels, activities, restaurants, etc. The server system 110 is configured to embed the hyperlinks to the travel itinerary such that when the travel event is clicked by a second traveler (e.g. the second traveler 106), the travel application 116 directs the second traveler to the third-party site associated with the travel event. For example, a travel itinerary of New York uploaded by the first traveler 102 may include travel events such as snacks at ABC coffee shop, visit XYZ casino on day 1 of the trip. The server system may generate the hyperlinks to both ABC coffee shop and XYZ casino and embed the hyperlinks with the travel itinerary.

In one embodiment, the first traveler 102 may publicly share the travel itinerary or may privately share a travel itinerary to another traveler on the travel application 116. The server system 110 may facilitate the second traveler 106 to view a travel itinerary created by the first traveler 102 and click on a travel event to view the booking choices on the booking site corresponding to the travel event.

At 315, the second traveler 106 may click on one of a travel event in the travel itinerary which directs the second traveler 106 to a third-party site. The second traveler 106 may open the third-party site to view the booking options on the third-party site. The third-party booking sites may be one of the booking websites of hotels, restaurants, activities, etc. The second traveler 106 may or may not make a booking after he/she has accessed the booking site. In one embodiment, the second traveler 106 may make a successful booking after accessing the booking site via the travel itinerary of the first traveler 102. In another embodiment, the second traveler 106 may make a booking for something similar or any other entity after accessing the booking site via the travel itinerary. For example, the second traveler 106 may access XYZ Inn to check accommodation facilities as posted by the first traveler 102, but after that, the second traveler 106 may book a table at XYZ inn only for a dinner. The server system is configured to receive an identifier regarding the bookings made by every traveler via the travel application 116.

At 320, the third-party booking sites are configured to send a notification to the server system 110 regarding a successful booking made by one or more second travelers. The notification may be an identifier that may be used by the server system 110 to identify a successful booking made by a second traveler 106 via the travel itinerary of a first traveler 102. For example, if the second traveler 106 makes a booking at the hotel XYZ by opening the booking site of XYZ hotel via the first traveler 102's travel itinerary shared using the travel application 116, the server system 110 is configured to receive a notification including the identifier including the first traveler's information and the booking information.

At 325, the server system 110 is configured to determine rewards to be provided to the first traveler 102 based on the successful bookings caused by the travel itinerary created by the first traveler 102. The rewards may be calculated using a tier-based approach in one embodiment. For example, a number of tiers may be pre-defined by the server system 110 such as 1-50 bookings per month, 51-100 bookings per month, and so on. The more the first traveler's itinerary causes a successful booking, the more will be the rewards for the first traveler 102. The rewards may be gift cards, coupons, materialistic things, free travel packages, discounts, and the like.

At 330, the server system 110 is configured to send the rewards to the first traveler 102. In one embodiment, the rewards may be sent to the first traveler 102 on the travel application 116. In the case of materialistic gifts, the notification may inform the traveler to claim the reward by entering certain details.

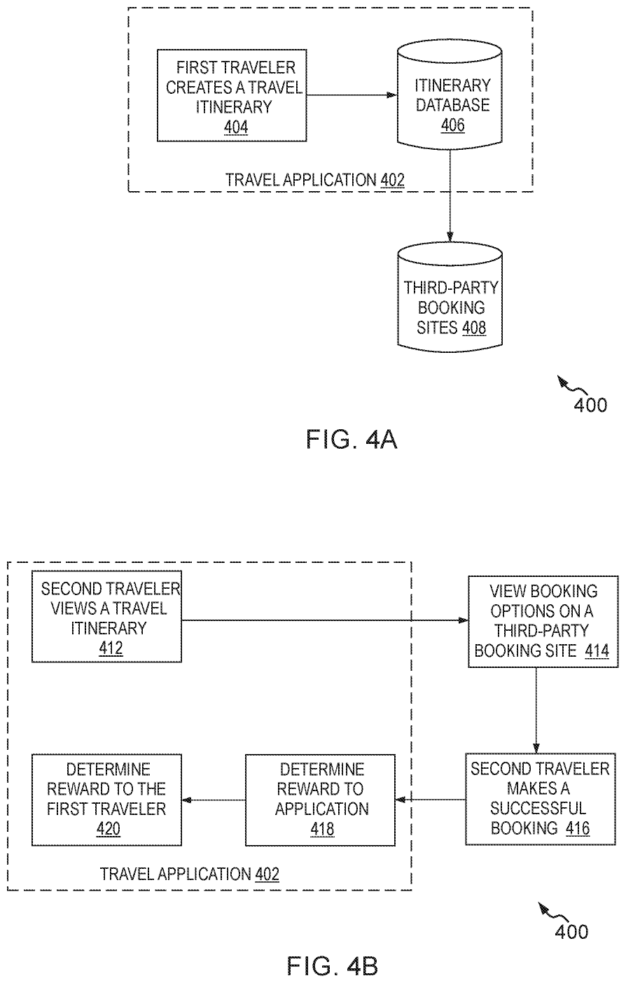

FIG. 4A is a block diagram 400 illustrating the creation of a travel itinerary by a first traveler (e.g., the first traveler 102), according to the embodiments as disclosed herein. The first traveler 102 may be utilizing a travel application 402 on his/her user device. The travel application may be downloaded onto the user device via the server system 200. Through the UI of the user device, via the travel application 402, the first traveler 102 may perform various operations disclosed herein.

At 404, the first traveler 102 may create/upload a travel itinerary for his/her travel plans through the travel application 402. The first traveler 102 may provide the information via a voice or text command. In some embodiments, upon the first traveler's consent, the travel application 402 is configured to automatically record the places that the first traveler 102 visited based on the locations of the GPS on the user device. The travel itinerary typically includes the starting point, places to visit during the travel, lodging accommodations, transportation, return dates, and so on. It will be appreciated that the travel itinerary can include plenty of other information such as user comments, photos, and small video snippets, etc.

The server system 200 may then store the travel itinerary created by the first traveler 102 in an itinerary database (see, 406). The itinerary database is configured to store all the travel itineraries uploaded by a plurality of travelers against their corresponding profiles.

The server system 200 is further configured to embed the travel itinerary with corresponding hyperlinks directed to third-party booking sites associated with third parties. The third-party booking sites may be one of a hotel website, a transportation booking website, a restaurant website, and the like. The travel itinerary with hyperlinks embedded to it may then be stored in the itinerary database (see, 408).

In an embodiment, when the first traveler 102 chooses to share the travel itinerary created by him/her publicly, the other travelers viewing the travel itinerary may click on the hyperlinks which directs them to the third-party booking sites of hotels, restaurants, activities, etc.

FIG. 4B is a block diagram 410 illustrating the process of rewarding a first traveler (e.g., the first traveler 102) based on a successful booking made by a second traveler (e.g., the second traveler 106), via the travel itinerary created by the first traveler 102 as described in FIG. 4A, according to the embodiments as disclosed herein.

At 412, the second traveler 106 may view a travel itinerary posted by the first traveler 102, on his/her user device using the travel application 402. The travel application is configured to display the plurality of travel itineraries to the second traveler 106 in a random manner or based on a second traveler's search. The second traveler 106 may enter a desired destination such as Las Vegas, Amsterdam, etc. The travel application 402 may facilitate the second traveler 106 to view various travel itineraries posted by a plurality of travelers.

In one embodiment, the travel application 402 is configured to allow the second traveler 106 to click on one of the plurality of hyperlinks present in the travel itinerary to view booking options on a third-party site. At 414, the second traveler 106 may click on one hyperlink and view booking options on a third-party site. The third-party site may be one of a website associated with a hotel, restaurant, activity, etc. For example, the second traveler 106 may click on a link directed to the website of XYZ hotel. The second traveler 106 may be provided with various booking options available at XYZ hotel for the desired date and time.

At 416, the second traveler 106 may make a successful booking by selecting one of the various booking options on the third-party site. The travel application 402 is configured to record every successful booking made by any of the travelers using the travel itineraries posted by other travelers. In the example, the second traveler 106 may book a stay at XYZ hotel by clicking on the hyperlink present in the travel itinerary created by the first traveler 102.

At 418, the travel application 402 may determine a reward provided to the travel application 402 from the third-party site. The third-party site may provide a commission to the server system 200 based on a successful booking made by every traveler via the travel application 402.

At 420, the travel application 402 via the server system 200 is configured to determine rewards to be given to the first traveler 102 whose travel itinerary was used by the second traveler 106 to make a successful booking. In an example embodiment, a tiered approach may be utilized by the server system 200 to determine the rewards. The tiers may be based on all the successful bookings made via the travel itinerary created by the first traveler 102. For e.g., tier 1 may include 0-50 successful bookings per month, tier 2 may include 51-150 successful bookings per month, tier 3 may include 150-500 successful bookings per month, and tier 4 may include 500+ successful bookings per month. Each tier may get a different percentage of the rewards received by the server system 200 from the third-party booking sites. Therefore, the rewards can be defined as directly proportional to the number of successful bookings made using the travel itinerary created by a traveler.

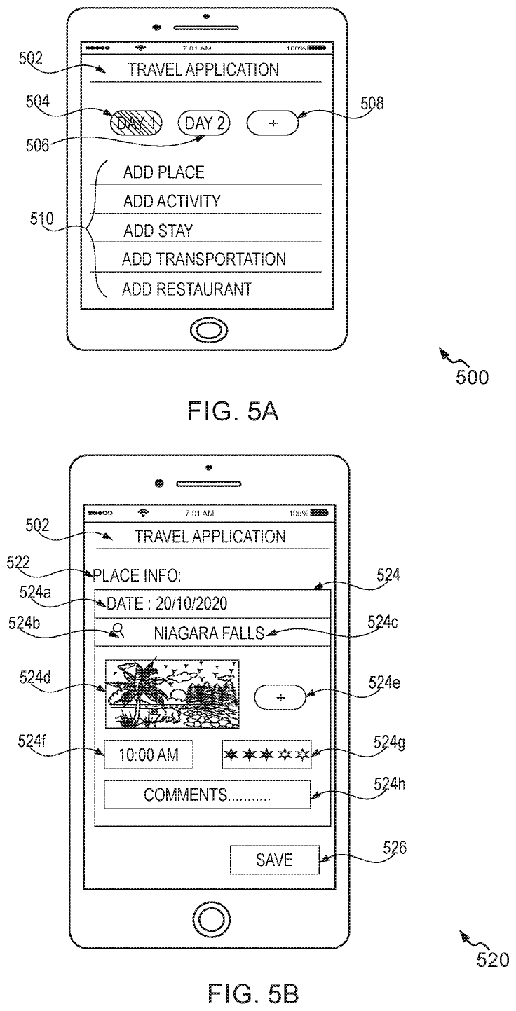

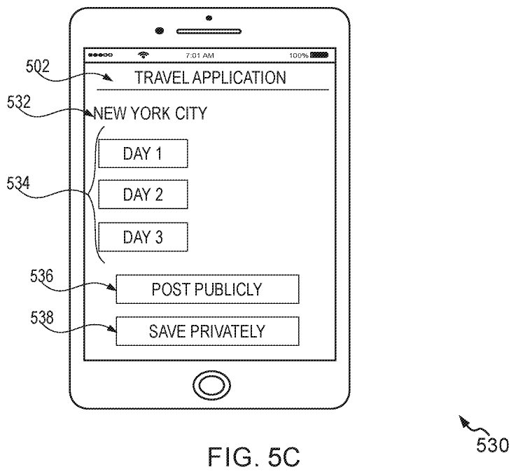

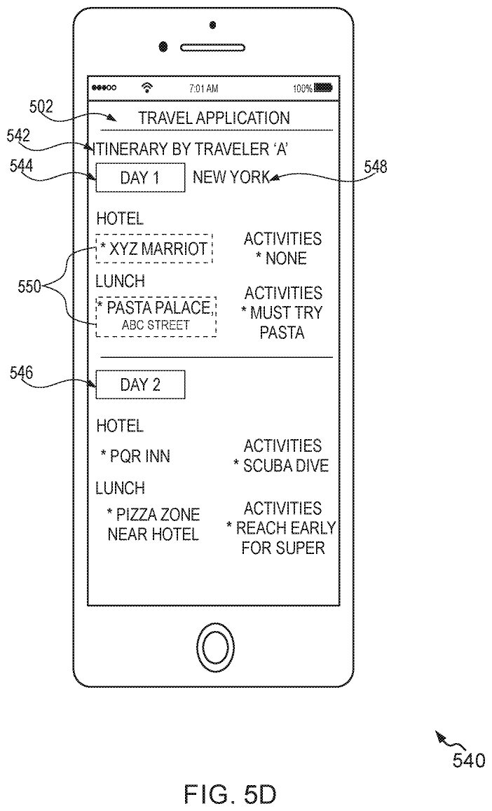

FIGS. 5A to 5D are example representations of UIs depicting some operations of the travel mobile application 126. The travel mobile application 126 may be used by a first traveler 102 to create a travel itinerary of the desired place and post it publicly or privately. Additionally, a second traveler 106 may view the travel itinerary posted by the first traveler 102 and click on any travel event on the travel itinerary to make a subsequent booking.

Referring now to FIG. 5A, an example representation of a UI 500 displayed on the first user device 104 by the travel mobile application 126 is illustrated, in accordance with an example embodiment. The name 502 of the travel mobile application 126 is exemplarily shown to be “Travel application”. The UI 500 depicts a page on the travel mobile application 126 which may be utilized by the first traveler 102 to create a travel itinerary.

The UI 500 is exemplarily shown to display the days in one trip. A day menu is exemplarily shown to depict the number of days that the first traveler 102 wants to add to the travel itinerary. It is exemplarily shown with text 504 and 506 that the first traveler 102 has chosen 2 days to be added to the travel itinerary. The first traveler 102 can use the actionable button 508 with the “+” symbol on it to add another day to be added on the travel itinerary.

The text day 1 is shaded to exemplarily depict that the first traveler 102 has chosen to add the travel events experienced by him/her on the first day of the trip. The actionable buttons 510 may be utilized by the first traveler 102 to add any of the travel events. For example, the actionable button with “Add activity” on it can be utilized by the first traveler 102 to add an activity done by the first traveler 102 on the first day of the trip. Similarly, the first traveler 102 can choose to add a hotel, stay, transportation, restaurant, and the like.

Referring now to FIG. 5B, an example representation of a UI 520 displayed on the first user device 104 by the travel mobile application 126 is illustrated, in accordance with an example embodiment. The name 502 of the travel mobile application 126 is exemplarily shown to be “Travel application”. The UI 520 depicts a page on the travel mobile application 126 which may be utilized by the first traveler 102 to add a place visited by the first traveler 102 during the trip. The UI 520 may be displayed to the first traveler 102 after the first traveler 102 has chosen the “Add place” button from the actionable buttons 510 as shown in the FIG. 5A.

The heading 522 with the text “place info” depicts that the first traveler 102 has to add the information regarding a place visited by the first traveler 102 during the trip. Further, the menu 524 is exemplarily shown to include a plurality of elements that allow the traveler to add information associated with the place.

The menu 524 includes a date box 524a that allows the first traveler 102 to add a date o visit to the place that the first traveler 102 is adding to the travel itinerary. A calendar may be shown to the traveler upon clicking the date box 524a to facilitate the first traveler 102 to enter the corresponding date. Further, a search box 524b is exemplarily shown inside the menu 524 which may allow the first traveler 102 to search for a place to be added. It is exemplarily shown that the first traveler 102 has entered a text 524c depicting that the traveler has searched for “Niagara falls”.

Further, a picture 524d is exemplarily shown depicting that the first traveler 102 has added a picture of the place. The “+” button 524e is displayed beside the picture depicting that the first traveler 102 may utilize the button to add more pictures and video snippets if he/she desires to. 524f is another text box that allows the traveler to add the time of visit to the place. The actionable icon 524g facilitates the first traveler 102 to rate the visit to the place. It is exemplarily shown in the UI 520 that the first traveler 102 has rated 3 out of 5 stars for the corresponding place. Furthermore, a comment box 524h is shown in the UI 520 that may allow the traveler to write comments on the experiences during the trip such as some important notes or the like.

Another actionable button 526 is shown in UI 520 with the text “SAVE”. The actionable button 526 when pressed by the traveler facilitates the server system 110 to store the travel itinerary to the itinerary database 124. Further, this progress can further be edited or deleted by the first traveler 102.

Referring now to FIG. 5C, an example representation of a UI 530 displayed on the first user device 104 by the travel mobile application 126 is illustrated, in accordance with an example embodiment. The name 502 of the travel mobile application 126 is exemplarily shown to be “Travel application”. The UI 530 depicts a page on the travel mobile application 126 displayed to the first traveler 102 after the first traveler 102 has finished updating the travel events of a travel itinerary.

A heading 532 with the text “New York City” depicts that the first traveler 102 has added a travel itinerary regarding his/her visit to New York City. Further, actionable buttons 534 may be displayed to the first traveler 102. The actionable buttons 534 may include corresponding buttons for each day of the itinerary such as Day 1, day 2, Day 3, and so on. The first traveler 102 can view and edit the travel events experienced by him/her on the corresponding days by clicking on the button of that particular day. Further, the travel mobile application 126 is configured to display clickable buttons 536 and 538 to the first traveler 102.

Button 536 with the text “post publicly” allows the first traveler 102 to post the travel itinerary on the travel application where any of the other travelers who have logged in to the travel application may view the travel itinerary. The button 538 with the text “save privately” allows the first traveler 102 to save travel itinerary privately onto their profile on the travel application where none of the other travelers who have logged in to the travel application can view the travel itinerary. The first traveler 102 can privately share the travel itinerary personally to desired travelers after saving the travel itinerary privately on his/her profile.

Referring now to FIG. 5D, an example representation of a UI 540 displayed on the second user device 108 by the travel mobile application 126 is illustrated, in accordance with an example embodiment. The name 502 of the travel mobile application 126 is exemplarily shown to be “Travel application”. The UI 540 depicts a page on the travel mobile application 126 displayed to the second traveler 106 where the second traveler 106 is viewing one of a travel itinerary posted by a first traveler 102 on the travel mobile application 126.

The heading 542 with the text “itinerary by traveler ‘A’” is exemplarily shown in the UI 540 depicting that the travel itinerary was posted by traveler ‘A’. In an example, the name of the traveler with which the traveler has logged in to the travel application may be displayed. Further, the headings 544 and 546 depict the days of the trip such as day 1, day 2. Furthermore, the heading 548 with the name of the place is exemplarily shown to be “New York” depicting that the travel itinerary is for New York City.

Each day of the travel itinerary may include travel events such as hotel, activities, food and comments as updated by the first traveler 102 during the creation of the travel itinerary. The day 1 of the travel itinerary is exemplarily shown to include ‘XYZ Marriott’ as hotel, activities as ‘none’, lunch as ‘pasta palace, ABC Street’, and comment as ‘must try pasta’. Further, as described earlier, the server system 110 is configured to embed hyperlinks to the travel events on the travel itinerary. It is exemplarily shown using the dotted lines that the travel events such as hotel and the lunch updated by the first traveler 102 on the day 1 of the trip are embedded with hyperlinks (see 550). The second traveler 106 may click on any one of the travel events to check the booking options of the sites of the corresponding travel event.

Similarly, the travel events under day 2 may also be embedded with hyperlinks that can be utilized by the second traveler 106 to view booking options and make a subsequent booking.

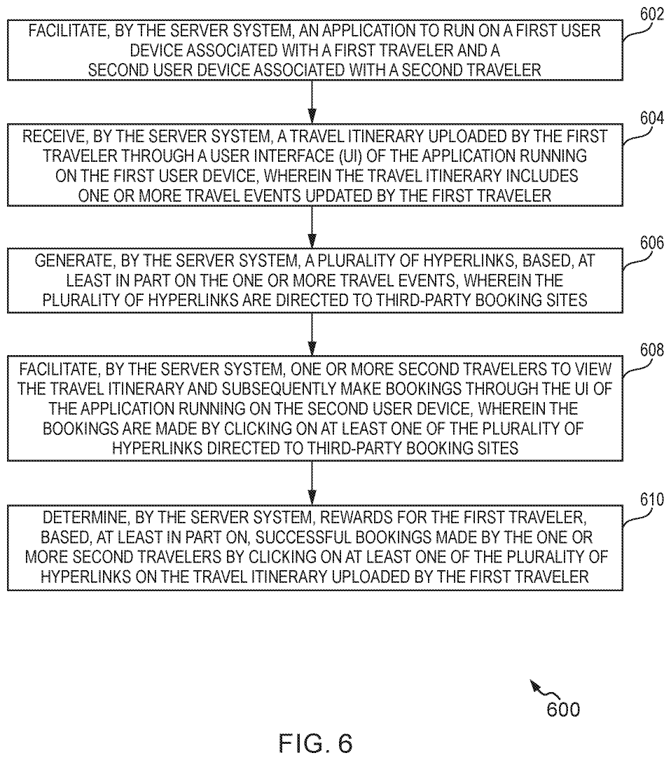

FIG. 6 is a flow diagram illustrating a method 600 for determining rewards for a first traveler 102, via an application. The operations of the method 600 may be carried out by a server such as the server system 110, the server system 200, or any one of the first and second user devices 104 and 108. The sequence of operations of the method 600 may not be necessarily executed in the same order as they are presented. Further, one or more operations may be grouped together and performed in form of a single step, or one operation may have several sub-steps that may be performed in parallel or in a sequential manner.

At 602, the method 600 includes, facilitating, by a server system 200, an application to run on a first user device 104 and a second user device 108. The first user device 104 may be associated with a first traveler 102 and the second user device 108 may be associated with a second traveler 106. The application may be downloaded via a suitable platform such as an application store on the first and second user devices 104 and 108. In alternate embodiments, the application may be accessed through a website or maybe browsed as a web application on the user device such as the first and second user devices 104 or 108.

At 604, the method 600 includes, receiving, by the server system 200, a travel itinerary uploaded by the first traveler 102 through a user interface (UI) of the application running on the first user device 104. The travel itinerary may include one or more travel events updated by the first traveler 102. The first traveler 102 may be allowed to upload a plurality of travel events using the application on the first user device 104. The travel events may include hotel stays, restaurant food, sightseeing places, activities, etc. The first traveler 102 may upload the travel itinerary during an ongoing trip or after the completion of the trip.

At 606, the method 600 includes, generating, by the server system 200, a plurality of hyperlinks, based, at least in part on the one or more travel events, wherein the plurality of hyperlinks are directed to third-party booking sites. The server system 200 is configured to generate a plurality of hyperlinks associated with the travel events included in the travel itinerary uploaded by the first traveler 102. The hyperlinks may be directed to third-party booking sites such as websites of hotels, restaurants, activities, etc.

At 608, the method 600 includes, facilitating, by the server system 200, one or more second travelers such as the second traveler 106 to view the travel itinerary and subsequently make bookings through the UI of the application running on the second user device 108, wherein the bookings are made by clicking on at least one of the plurality of hyperlinks directed to third-party booking sites. The server system 200 is configured to facilitate one or more second travelers to view the travel itinerary posted by the first traveler 102. For example, the second traveler 106 may open a hyperlink and make a successful booking on the third-party site. The server system 200 may determine the successful booking based on an identifier.

At 610, the method 600 includes, determining, by the server system 200, rewards for the first traveler 102, based, at least in part on, successful bookings made by the one or more second travelers such as the second traveler 106 by clicking on at least one of the plurality of hyperlinks on the travel itinerary uploaded by the first traveler 102. In one embodiment, the server system 200 is configured to determine rewards for the first traveler 102 based on a tiered approach. The more the bookings made via a first traveler's travel itinerary, the more the rewards. In one embodiment, the server system 200 may determine a reward to the first traveler 102 based on a commission received by the server system 200 from the third-party booking sites.

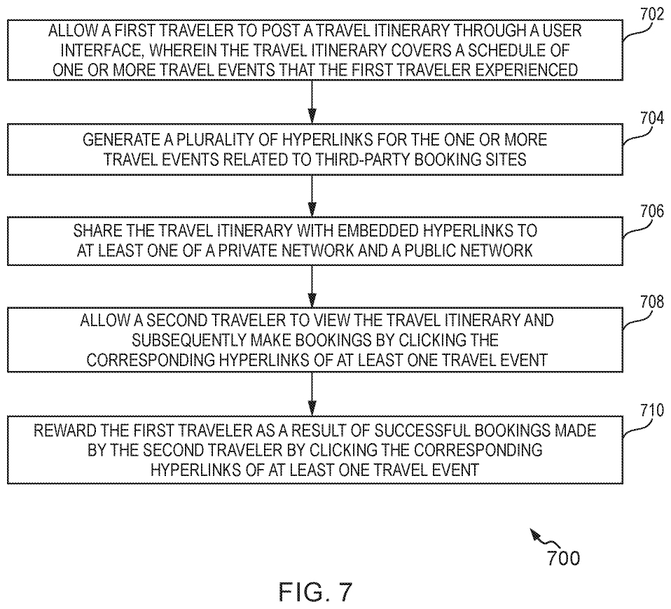

FIG. 7 is a flow diagram 700 illustrating a method for rewarding a first traveler (e.g., the first traveler 102) for causing bookings with their travel itinerary, according to the embodiments as disclosed herein. The sequence of operations of the method 700 may not be necessarily executed in the same order as they are presented. Further, one or more operations may be grouped together and performed in form of a single step, or one operation may have several sub-steps that may be performed in parallel or in a sequential manner. The flow diagram begins as 702.

The method described herein characterizes a first traveler 102 and a second traveler 106. The first traveler 102 is an individual who creates a travel itinerary and shares it across a network. The second traveler 106 is an individual who views the travel itinerary and finds one or more travel events appealing. It must be noted that the method described herein can illustrate a plurality of travelers who view the travel itinerary.

At step 702, the first traveler 102 is allowed to post a travel itinerary through a user interface of the travel application. The travel itinerary covers a schedule of one or more travel events that the first traveler 102 experienced.

The first traveler 102 is allowed to post his/her travel itinerary through the user interface before or during his/her journey/trip. In some embodiments, the first traveler 102 may post the travel itinerary after he/she completes the journey. The travel itinerary includes information on several developments (events) that took place during the travel. Examples of the information include, but are not limited to, hotel, food, point of interest, excursions, and other activities.

In some embodiments, in addition to sharing the travel itinerary through the public network and/or private network, the travel itinerary is also shared privately to an individual via a link.

Having a travel itinerary is as important as choosing where to go and where to stay. Typically, travel itineraries ensure time management and management of expenditures. Estimating the cost of travel beforehand makes it easier to plan the budget. Further, travel itineraries make it easier for travelers to travel faster from one point to another.

At 704, a plurality of hyperlinks is generated for the one or more travel events included in the travel itinerary posted by the first traveler. The hyperlinks may be directed to third-party booking sites.

As described in FIG. 2 the server system 200 is configured to generate and embed the hyperlinks that connect the first traveler's travel events with the related third-party booking sites. The hyperlinks typically connect webpages to other webpages. Specifically, in this scenario, the hyperlinks connect the travel events to the related third-party booking sites. Consequent to clicking a hyperlink, the traveler/user is allowed to jump to the connected website.

The hyperlinks are important as it helps to identify/track the traffic that comes via the travel application. Additionally, the links provide simple means of navigation between pages on the web.

In some embodiments, the platform will have a unique identifier for each itinerary. This identifier helps to identify the bookings made on the third-party site via the travel application on the user device. The travel application 116 may use this information for paying the commission to the first traveler

At 706, the travel itinerary is shared with the embedded hyperlinks to at least one of a private network and a public network. The private network is a connection within a specific network with access restrictions. On the other hand, the public network is a network that connects everybody and anybody.

In some embodiments, the first traveler's travel authenticity is validated before posting the travel itinerary in the private or public networks.

At 708, the second traveler such as the second traveler 106 is allowed to view the travel itinerary created and shared by the first traveler 102 and subsequently make bookings by clicking the corresponding hyperlinks of at least one travel event.

The second traveler 106 may view the travel itinerary shared by the first traveler 102. Subsequently, the second traveler 106 is allowed to click on one or more hyperlinks that interest him/her. As a result of this action, the second traveler 106 is allowed to view the related third-party booking sites. The bookings of interested events are then made through third-party booking sites.

Once the second traveler 106 lands on the third-party booking sites, the method described herein facilitates commission on other booking entities. In other words, the second traveler 106 may load the primary travel-element link from the first traveler's travel itinerary and then browse other travel elements on the third-party booking sites and book the same.

In one embodiment, when the second traveler 106 clicks on a hyperlink, a list of pricing of all third-party booking sites are displayed. For example, pricing from ABC hotel, PQR hotel, XYZ hotel, and so on.

At 710, the first traveler is rewarded as a result of successful bookings made by the second traveler such as the second traveler 106 by clicking on the corresponding hyperlinks of at least one travel event.

Upon completion of the second traveler 106's travel plan, the first traveler 102 is rewarded appropriately. The rewards are typically in the form of commissions, bonuses, gifts, and promotions. The reward may also be based on the server system 200 receiving the commission from the third-party site. It will be appreciated that the rewards may be in any suitable form and is not limited to the forms listed above.

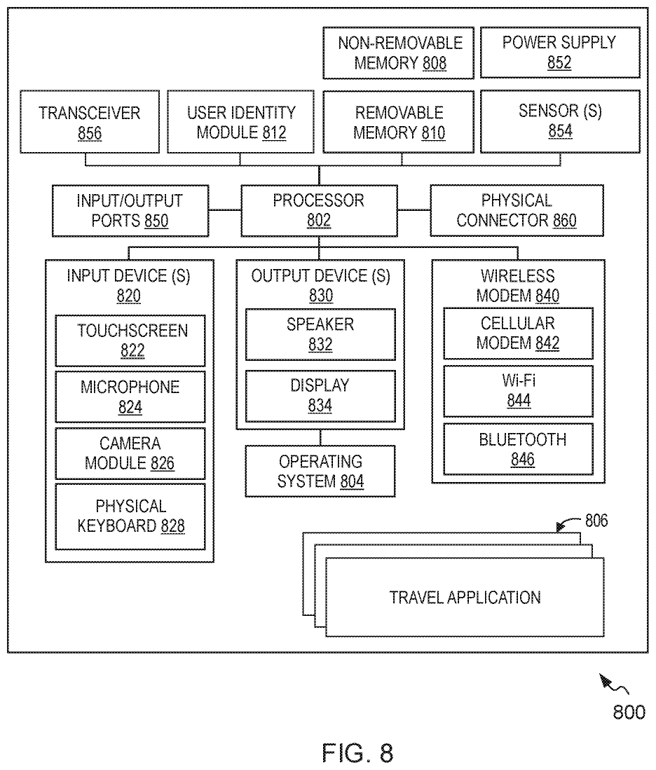

FIG. 8 is a simplified block diagram of an electronic device 800 capable of implementing the various embodiments of the present disclosure. The electronic device 800 may be an example of any one of the first and second user devices 104 and 108 as shown in FIG. 1A. It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an example embodiment may include more, less, or different components than those described in connection with the example embodiment of FIG. 8. As such, among other examples, the electronic device 800 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the electronic device 800 and provides support for one or more applications programs, such as the travel application that implements one or more of the innovative features described herein. The applications 806 may include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 800 includes one or more memory components, for example, a non-removable memory 808 and/or a removable memory 810. The non-removable memory 808 and/or the removable memory 810 may be collectively known as the database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804. The electronic device 800 may further include a user identity module (UIM) 812. The UIM 812 may be a memory device having a processor built-in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to, a speaker 832 and a display 834. Other possible output devices can include piezoelectric or other haptic output devices. Some devices can serve more than one input/output function. For example, the touch screen 822, and the display 834 can be combined into a single input/output device.

A wireless modem 840 can be coupled to one or more antennas (not shown in FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 8, or one or more operations of the method 600 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

It is to be understood that although various components are illustrated herein as separate entities, each illustrated component represents a collection of functionalities which can be implemented as software, hardware, firmware, or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies, and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies, and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on the computer-readable media as computer program products. Any form of the computer-readable medium can be used in this context, such as magnetic or optical storage media. Additionally, software portions of the present invention can be instantiated (for example as object code or executable images) within the memory of any programmable computing device.

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions, when executed on the computer or other programmable data processing apparatus, creates a means for implementing the functions specified in the flowchart block or blocks. Although other means for implementing the functions including various combinations of hardware, firmware, and software as described herein may also be employed.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such are intended to cover the application and\or implementation without departing from the spirit or scope of the claims.

What is claimed is:

1. A computer-implemented method comprising:
facilitating, by a server system, an application to run on a first user device associated with a first traveler and a second user device associated with a second traveler;
receiving, by the server system, a travel itinerary uploaded by the first traveler through a user interface (UI) of the application running on the first user device, wherein the travel itinerary comprises one or more travel events updated by the first traveler;
generating, by the server system, a plurality of hyperlinks, based, at least in part on the one or more travel events, wherein the plurality of hyperlinks is directed to third-party booking sites;
facilitating, by the server system, one or more second travelers to view the travel itinerary and subsequently make bookings through the UI of the application running on the second user device, wherein the bookings are made by clicking on at least one of the plurality of hyperlinks directed to third-party booking sites; and
determining, by the server system, rewards for the first traveler, based, at least in part on, successful bookings made by the one or more second travelers by clicking on at least one of the plurality of hyperlinks on the travel itinerary uploaded by the first traveler.

2. The computer-implemented method as claimed in claim 1, further comprising embedding, by the server system, the plurality of hyperlinks to the travel itinerary, wherein the plurality of hyperlinks are accessible by the one or more second travelers on the UI of the application running on their respective user devices.

3. The computer-implemented method as claimed in claim 2, wherein the plurality of hyperlinks are directed to the third-party booking sites associated with at least one of: hotels, home-sharing, destinations, excursions, restaurants, flights, and transportation.

4. The computer-implemented method as claimed in claim 1, further comprising receiving, by the server system, a notification from a third-party booking site, wherein the notification comprises one or more identifiers associated with successful bookings made by the one or more second travelers.

5. The computer-implemented method as claimed in claim 1, wherein determining rewards for the first traveler comprises calculating rewards, based, at least in part, on a tiered approach.

6. The computer-implemented method as claimed in claim 5, further comprising sending, by the server system, rewards to the first user device, wherein the rewards are directly proportional to a number of successful bookings made by the one or more second travelers by using the travel itinerary uploaded by the first traveler.

7. The method as claimed in claim 1, wherein the application is one of a mobile application, a computer application, and a web application.

8. The computer-implemented method as claimed in claim 1, further comprising allowing, by the server system, the first traveler to attach photos and videos along with the one or more travel events in the travel itinerary.

9. The computer-implemented method as claimed in claim 1, further comprising storing, by the server system, traveler details associated with a plurality of travelers and travel itineraries associated with the plurality of travelers.

10. The computer-implemented method as claimed in claim 1, further comprising facilitating, by the server system, the first traveler to post the travel itinerary onto social networking sites via the application.

11. A server system, comprising:
a memory configured to store executable instructions; and
a processor configured to execute the executable instructions stored in the memory and thereby cause the server system, at least in part, to:
facilitate an application to run on a first user device and a second user device, wherein the first user device is associated with a first traveler and the second user device is associated with a second traveler;
receive a travel itinerary uploaded by the first traveler through a user interface (UI) of the application running on the first user device, wherein the travel itinerary comprises one or more travel events updated by the first traveler;
generate a plurality of hyperlinks, based, at least in part on the one or more travel events, wherein the plurality of hyperlinks are directed to third-party booking sites;
facilitate one or more second travelers to view the travel itinerary and subsequently make bookings through the UI of the application running on the second user device, wherein the bookings are made by clicking on at least one of the plurality of hyperlinks directed to third-party booking sites; and
determine rewards for the first traveler, based, at least in part on, successful bookings made by the one or more second travelers by clicking on at least one of the plurality of hyperlinks on the travel itinerary uploaded by the first traveler.

12. The server system as claimed in claim 11, wherein the server system is further caused at least in part to embed the plurality of hyperlinks to the travel itinerary, wherein the plurality of hyperlinks are accessible by the one or more second travelers on the UI of the application running on their respective user devices.

13. The server system as claimed in claim 12, wherein the plurality of hyperlinks are directed to third-party booking sites associated with at least one of hotels, home-sharing, destinations, excursions, restaurants, flights, transportation, and activities.

14. The server system as claimed in claim 11, wherein the server system is further caused at least in part to receive a notification from a third-party booking site, wherein the notification comprises one or more identifiers associated with successful bookings made by the one or more second travelers.

15. The server system as claimed in claim 11, wherein the server system is further caused at least in part to determine rewards for the first traveler by calculating rewards, based, at least in part, on a tiered approach.

16. The server system as claimed in claim 15, wherein the server system is further caused at least in part to send rewards to the first user device, wherein the rewards are directly proportional to a number of successful bookings made by the one or more second travelers by using the travel itinerary uploaded by the first traveler.

17. The server system as claimed in claim 11, wherein the server system is further caused at least in part to allow the first traveler to attach photos and videos along with the one or more travel events in the travel itinerary.

18. The computer-implemented method as claimed in claim 11, wherein the server system is further caused at least in part to store traveler details associated with a plurality of travelers and travel itineraries associated with the plurality of travelers.

19. The server system as claimed in claim 11, wherein the server system is further caused at least in part to facilitate the first traveler to post the travel itinerary onto social networking sites via the application.

20. A system comprising:
a database configured to store a plurality of itineraries creates by a plurality of travelers;
a user interface (UI) module in communication with the database, the UI module configured to present one or more user interfaces (UI's) for facilitating the plurality of travelers to create, upload and view, one or more of travel itineraries;
an application management module configured to manage downloads and usage of an application on a plurality of user devices;
an itinerary creation module in communication with the UI module and the database, the itinerary creation module configured to generate travel itineraries based at least one of a travel event updated by a traveler through the application on a user device;
an itinerary sharing module in communication with the UI module and the database, the itinerary sharing module configured to facilitate one or more travelers to click on at least one hyperlink embedded in a travel itinerary and make a subsequent booking; and
a traveler reward module in communication with the UI module and the database, the traveler reward module configured to determine rewards for the plurality of travelers.
